(19) United States
(12) Patent Application Publication
(10) Pub. No.: US 2026/0145564 A1
(43) Pub. Date: May 28, 2026

(54) CHARGING STATION

(71) Applicant: TOYOTA JIDOSHA KABUSHIKI KAISHA, Toyota-shi (JP)

(72) Inventor: Takeshi ASHIDA, Okazaki-shi (JP)

(73) Assignee: TOYOTA JIDOSHA KABUSHIKI KAISHA, Toyota-shi (JP)

(21) Appl. No.: 19/286,779

(22) Filed: Jul. 31, 2025

(30) Foreign Application Priority Data
Nov. 25, 2024 (JP) 2024-204776

(51) Int. Cl. B60L 53/31; B60L 53/16

(52) U.S. Cl. CPC B60L 53/31; B60L 53/16

(57) ABSTRACT

A charging station for charging a first target object includes a main body portion having a storage portion that is capable of storing a charging connector that charges the first target object, and a power output portion provided in the storage portion and configured to supply power to a second target object, in which, when the charging connector is stored in the storage portion, the power output portion is covered by the charging connector and becomes inaccessible from the outside of the charging station.

### CROSS-REFERENCE TO RELATED APPLICATION

This application claims priority to Japanese Patent Application No. 2024-204776 filed on Nov. 25, 2024. The disclosure of the above-identified application, including the specification, drawings, and claims, is incorporated by reference herein in its entirety.

### BACKGROUND

### 1. Technical Field

The present disclosure relates to a charging station.

### 2. Description of Related Art

A charging station is known from the related art. For example, Japanese Unexamined Patent Application Publication No. 2012-165533 (JP 2012-165533 A) discloses a module of charging equipment for an electric vehicle. The module includes a charging cable provided with a charging gun connected to a connection portion of an electric vehicle in a pluggable and unpluggable manner, and a box-shaped housing that stores the charging gun in a detachable and attachable manner in a storage space.

### SUMMARY

In a charging station, a charging connector is connected to a first target object to charge the first target object. A storage portion is provided in a main body portion of the charging station, and the charging connector is stored in the storage portion when charging is not performed. There are cases where power supply to a second target object, other than the first target object charged by the charging connector, is desired.

The present disclosure has an object to provide a charging station that is configured to perform power supply to a second target object other than a first target object to be charged by a charging connector stored in a storage portion of a main body portion.

A charging station based on an aspect of the present disclosure is a charging station for charging a first target object.

The charging station includes a main body portion including a storage portion, the storage portion configured to store a charging connector for charging the first target object, and a power output portion provided in the storage portion and configured to supply power to a second target object.

When the charging connector is stored in the storage portion, the power output portion is covered by the charging connector, and thus the power output portion becomes inaccessible from the outside of the charging station.

With the above configuration, it is possible to perform, by using the power output portion, power supply to the second target object other than the first target object to be charged by the charging connector. When charging is not performed by the charging connector, the charging connector is stored in the storage portion, and the power output portion is covered by the charging connector, so that the power output portion becomes inaccessible from the outside of the charging station, and thus the possibility of unauthorized power usage can be reduced.

In the charging station,
the power output portion may include a first power supply port configured to charge a battery mounted in a vehicle.

With this configuration, for example, when charging is being performed by the charging connector, it is possible to charge the battery mounted in the vehicle by using the first power supply port.

In the charging station,
the power output portion may include a second power supply port configured to supply power to an electrical device other than the battery mounted in the vehicle.

With this configuration, for example, when charging is being performed by the charging connector, it is possible to supply power to the electrical device other than the battery mounted in the vehicle by using the second power supply port.

In the charging station,
the power output portion may include a third power supply port configured to charge a portable battery mounted in the vehicle.

With this configuration, for example, when charging is being performed by the charging connector, it is possible to charge the portable battery mounted in the vehicle by using the third power supply port.

According to the present disclosure, it is possible to obtain the charging station that is configured to perform power supply to the second target object other than the first target object to be charged by the charging connector stored in the storage portion of the main body portion.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a front view of a charging station 1 in an Embodiment 1;

FIG. 2 is a diagram showing a side view of the charging station 1 in the Embodiment 1;

FIG. 3 is a diagram schematically showing an internal structure of a main body portion 2 provided in the charging station 1 in the Embodiment 1; and

FIG. 4 is a diagram schematically showing a state in which power supply is performed by the charging station 1 in the Embodiment 1.

### DETAILED DESCRIPTION OF EMBODIMENTS

Hereinafter, embodiments will be described with reference to the drawings. In the following description, the same reference numerals are given to the same components. The names and functions thereof are also the same. Therefore, a detailed description thereof will not be repeated.

### Embodiment 1

### Charging Station 1

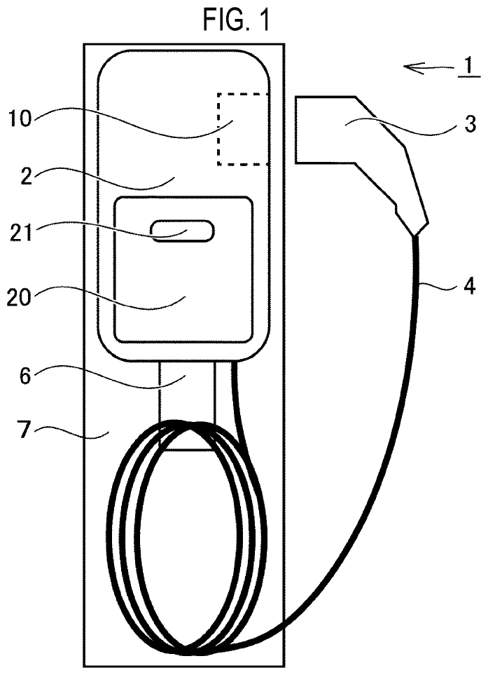

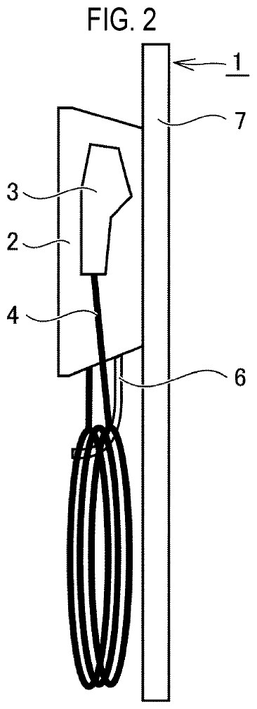

FIG. 1 is a diagram showing a front view of a charging station 1 in Embodiment 1, and FIG. 2 is a diagram showing a side view of the charging station 1 in Embodiment 1. The charging station 1 includes a main body portion 2, a charging connector 3, a charging cable 4, a holding portion 6, and a wall 7.

### Main Body Portion 2

The wall 7 is disposed on a back surface side of the main body portion 2 and the holding portion 6, and supports the main body portion 2 at a predetermined height. The main body portion 2 has a storage portion 10 described below, and the holding portion 6 protrudes from below the main body portion 2. The charging connector 3 is stored in the storage portion 10. The charging connector 3 is removed from the storage portion 10 when the vehicle is charged, and is returned to the storage portion 10 when the charging of the vehicle is finished. The charging cable 4 connects the main body portion 2 and the charging connector 3. By hooking a part of the charging cable 4 to the holding portion 6, the charging cable 4 can be stored in the charging station 1.

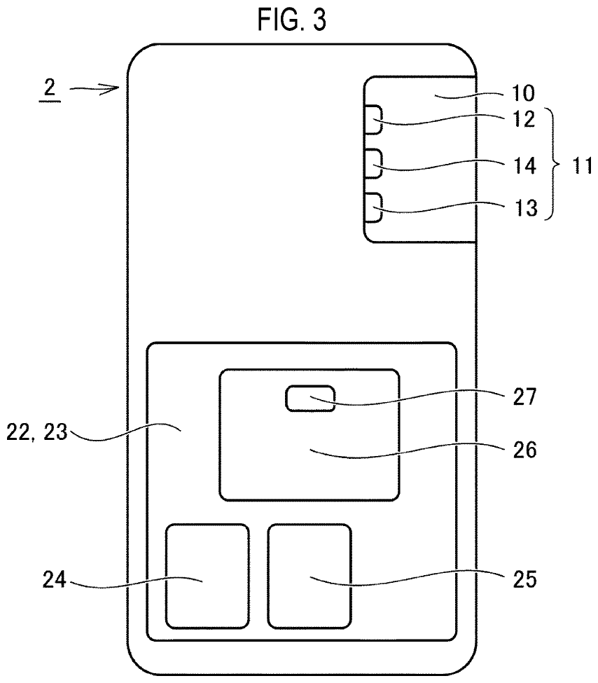

FIG. 3 is a diagram schematically showing an internal structure of the main body portion 2. The main body portion 2 includes the storage portion 10, a door body 20 (FIG. 1), an opening surface 22, and an internal space 23. The door body 20 is capable of closing the opening surface 22 in an openable and closable manner. The internal space 23 can be accessed through the opening surface 22. An indicator lamp viewing window 21 to be described later is provided in the door body 20.

### Storage Portion 10

The storage portion 10 is for storing the charging connector 3. The storage portion 10 has, for example, a recessed shape from the side surface of the main body portion 2, and the charging connector 3 is held by the main body portion 2 by inserting the tip end portion of the charging connector 3 into the storage portion 10.

### Power Output Portion 11

A power output portion 11 is provided in the storage portion 10. The power output portion 11 is provided in, for example, the inside of the recessed shape of the storage portion 10. When the charging connector 3 is stored in the storage portion 10, the power output portion 11 is covered by the charging connector 3, and thus the power output portion 11 becomes inaccessible from the outside of the charging station 1. The power output portion 11 (FIG. 3) may include any one or a plurality of or all of a first power supply port 12, a second power supply port 13, and a third power supply port 14.

For example, any battery mounted in a vehicle can be charged with the power output from the first power supply port 12. Any battery may be any battery mounted in a vehicle that is charged using the charging connector 3, or may be any battery mounted in a vehicle different from the vehicle. The first power supply port 12 may be an additional charging port for charging a vehicle different from the vehicle that is being charged using the charging connector 3. The additional charging port can be connected to, for example, a Mode 2 cable.

The power output from the second power supply port 13 may be supplied to, for example, an electrical device other than a battery mounted in the vehicle. The second power supply port 13 may be a general-purpose power outlet for using other electrical products, such as a high-pressure vehicle washing machine.

A portable battery mounted in the vehicle may be charged with the power output from the third power supply port 14, for example. The portable battery may be a portable battery mounted in a vehicle that is charged using the charging connector 3, or may be a portable battery mounted in a vehicle different from the vehicle. The third power supply port 14 may be a dedicated port for charging a portable power source placed in the vehicle.

The internal space 23 stores a substrate 24, a control circuit 25, and a charging circuit interruption device (CCID) 26. The charging circuit interruption device 26 includes an indicator lamp 27. The charging circuit interruption device 26 is disposed at a position where the indicator lamp 27 can be visually recognized through the indicator lamp viewing window 21 when the indicator lamp viewing window 21 is viewed from the outside of the main body portion 2 in a state where the door body 20 is closed.

### Action and Effect

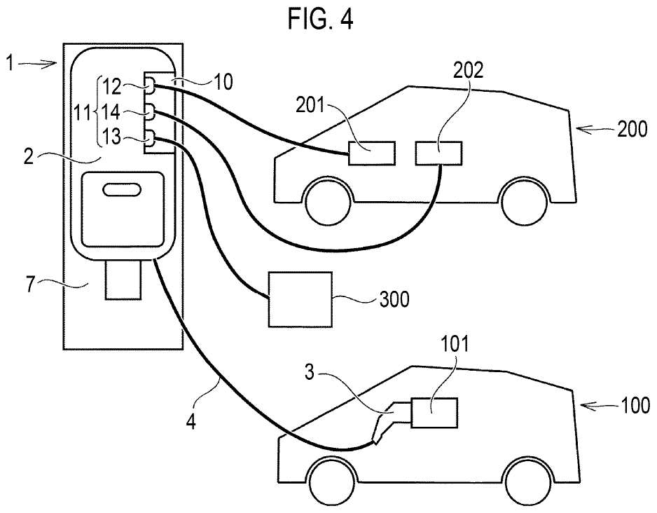

FIG. 4 is a diagram schematically showing a state in which the power supply is performed by the charging station 1. By providing the first power supply port 12, the second power supply port 13, and the third power supply port 14 in the charging station 1, it is possible to supply power to targets other than the vehicle, and the power supply by the charging station 1 becomes more convenient, for example, in parking lots of homes, workplaces, and commercial facilities.

When the charging connector 3 is stored in the storage portion 10, the charging connector 3 covers the storage portion 10, and thus the power output portion 11 is inaccessible from the outside of the charging station 1. Therefore, it is possible to prevent the unauthorized power usage by the third party.

As shown in FIG. 4, by providing the first power supply port 12 in the storage portion 10, a battery 101 (first target object) mounted in one vehicle (for example, battery electric vehicle 100) is to be charged using the charging connector 3. At the same time, batteries 201, 202, or the like (second target object) mounted in another vehicle (for example, the battery electric vehicle 200) can be charged. As a result, it is possible to reduce the waiting time for charging of the user.

Since the charging station 1 is available for multipurpose use by the second power supply port 13, it is possible to use an electrical device other than the battery mounted in the vehicle, such as a high-pressure vehicle washing machine 300, by supplying the power from the charging station 1. That is, the purpose of using the charging station 1 is further expanded from the conventional purpose of charging the vehicle, and as a result, the convenience of the user of the charging station 1 is improved.

The portable battery (for example, the battery 202) placed in the vehicle can be charged without taking the portable battery out of the vehicle by using the third power supply port 14. Therefore, there is no need to bring the portable battery home to charge.

Even in a state where the door body 20 is closed, the indicator lamp 27 can be seen through the indicator lamp viewing window 21, so that the visibility of the indicator lamp 27 is improved, and the state of the charging circuit interruption device 26 is easy to understand.

The members of the charging station 1, such as the substrate 24 and the control circuit 25, are stored in the internal space 23 of the main body portion 2, so that the compactness and the functionality of the charging station 1 are maintained.

### Embodiment 2

Hereinafter, Embodiment 2 will be described with reference to the difference from the above-described Embodiment 1.

In the above-described Embodiment 1, the charging station 1 includes the charging cable 4 and the charging connector 3. The charging station 1 can also be implemented as a so-called intermediate product. For example, even in a case of the charging station 1 as an intermediate product that does not include the charging cable 4 and the charging connector 3, the power output portion 11 is covered by the charging connector 3 by storing the charging connector 3 in the storage portion 10 of the intermediate product. As a result, the power output portion 11 becomes inaccessible from the outside of the charging station 1, and it is possible to prevent the unauthorized power usage. In addition, power can be supplied to any electrical device by using the power output portion 11 in a state in which the charging connector 3 is removed from the storage portion 10.

A plurality of power output portions 11 may be installed in the storage portion 10, and a dedicated power output portion 11 may be provided for each use. It is possible to supply stable power as described below and to supply power that secures the quality of the precision equipment.

In the charging station 1, the power output portion 11 may be a power outlet that can supply power to the external device in an emergency, such as a natural disaster or a power failure. When the emergency occurs, the charging station 1 is switched to the emergency power supply mode, and thus stable power can be supplied to the household electrical appliance or the medical device.

The power output portion 11 may be a power port for an in-vehicle office. For example, an additional power port that can be connected to a laptop computer, a printer, a mobile device, or the like is installed in the housing.

The embodiments disclosed this time should be considered illustrative and not restrictive in all respects. The scope of the present disclosure is indicated by the scope of claims rather than by the above description, and is intended to include all modifications within the scope and meaning equivalent to the scope of the claims.

What is claimed is:

1. A charging station for charging a first target object, the charging station comprising:
a main body portion including a storage portion, the storage portion configured to store a charging connector for charging the first target object; and
a power output portion provided in the storage portion and configured to supply power to a second target object,
wherein when the charging connector is stored in the storage portion, the power output portion is covered by the charging connector and becomes inaccessible from an outside of the charging station.

2. The charging station according to claim 1, wherein the power output portion includes a first power supply port configured to charge a battery mounted in a vehicle.

3. The charging station according to claim 1, wherein the power output portion includes a second power supply port configured to supply power to an electrical device other than a battery mounted in a vehicle.

4. The charging station according to claim 1, wherein the power output portion includes a third power supply port configured to charge a portable battery mounted in a vehicle.
